(19) United States
(12) Patent Application Publication
(10) Pub. No.: US 2018/0264694 A1
(43) Pub. Date: Sep. 20, 2018

(54) MOLDING COMPONENTS

(71) Applicant: HEWLETT-PACKARD DEVELOPMENT COMPANY, LP., HOUSTON, TX (US)

(72) Inventors: WEI-FENG YEN, TAIPEI CITY (TW); QIU FENG YU, TAIPEI CITY (TW); CHIENCHIH CHIU, TAIPEI CITY (TW); BIN CHEN, SHANGHAI (CN)

(21) Appl. No.: 15/760,943

(22) PCT Filed: Nov. 11, 2015
(86) PCT No.: PCT/CN2015/094309

§ 371 Date: Mar. 16, 2018

(51) Int. Cl. B29C 45/14; B29C 45/26; B29C 45/03; B22D 17/00

(52) U.S. Cl. CPC B29C 45/14065; B22D 17/002; B29C 45/03; B29C 45/26

(57) ABSTRACT

Examples of techniques for molding molded components are described herein. In an example, a molding apparatus for molding a molded component includes a first mold-half comprising a mold-facing surface, and a slider member mounted on the first mold-half and movable substantially along the mold-facing surface. The first mold-half and the slider member can form a part of a mold cavity therebetween. Further, the molding apparatus includes a second mold-half to cooperate with the first mold-half to complete the mold cavity with the first mold-half and the slider member. The slider member is movable to modify a draft angle provided in the mold cavity.

### BACKGROUND

Molding is one of the most commonly used manufacturing processes for mass manufacturing of components and can use a host of materials. The process involves shaping a material in molten form into a predefined shape of a component by pouring the molten material in a cavity of the predefined shape, the cavity being formed in a molding apparatus. The cavity having the predefined shape is referred to as a mold cavity. For example, injection molding, a generally used molding technique, involves manufacturing of parts or components by injecting a molten material into the mold cavity, allowing the material to cool, and, then, removing the solidified material from the mold cavity.

### BRIEF DESCRIPTION OF FIGURES

The detailed description is provided with reference to the accompanying figures. It should be noted that the description and the figures are merely examples of the present subject matter and are not meant to represent the subject matter itself.

FIG. 1 illustrates a schematic of a molding apparatus, according to an example.

FIG. 2 illustrates a schematic of an injection molding system according to an example.

FIG. 3a and FIG. 3b illustrate cross-sectional views of a molding unit of the injection molding system, according to an example.

FIG. 4 illustrates a method for molding a molded component, according to an example.

### DETAILED DESCRIPTION

Generally, for manufacturing a component by molding, molten material is poured into a mold cavity in a molding apparatus, and is removed upon solidification. The mold apparatus, usually, includes two blocks and the mold cavity can be formed between the two blocks. For example, one block can form lateral walls and one of the non-lateral walls of the mold cavity and the second block can couple to the first block to close the mold cavity by forming the other non-lateral wall of the cavity.

Further, tolerances can be, generally, provided in the mold cavity, for instance, for ease of removal of a molded component from the mold cavity. For example, a draft angle, i.e., an outward taper from the non-lateral wall to an open edge of the lateral wall, can be provided in the lateral walls of the mold cavity. In other cases where the molding apparatus is used for molding the components of slightly different dimensions, the invariability of dimensions of the mold cavity can lead to existence of the tolerances. Accordingly, the molded component has greater dimensions than those to be achieved for the component. Therefore, the molded component has to be processed, for example, polished or machined, to remove excess material for achieving the relevant dimensions.

In addition, in cases where a component is to be molded with another component, one component is positioned in the mold cavity and the second component is molded with the first component by pouring molten material over the first component. However, the molten material may flow into a gap between the first component and the mold cavity due to the tolerances. As a result, the material of the second component can overflow over the first component, leading to lack of finishing in the molded component. In addition, removal of the overflown material may cause damage to the other component. In turn, removing the overflown material with precision may involve expensive and complex equipment or skilled labor, or both.

The present subject matter relates to a provision of a slider member in a molding apparatus, such as an injection molding system, to avoid the over-molding of molten material in a mold cavity of the molding apparatus. The provision of the slider member provides for minimizing tolerances while molding using the molding apparatus. Such a provision provides for high quality of the molded component, and hence, the productivity.

The molding apparatus can include a first mold-half, a second mold-half, and a mold cavity is formed therebetween when assembled. According to an example, the first mold-half can be provided with the slider member and the mold cavity can be formed between the slider member, the first mold-half, and the second mold-half. For instance, the slider member can form walls of an open cavity and the first mold-half can form one end of the open cavity. Accordingly, the cavity can be closed when the second mold-half is assembled with the first mold-half.

According to an aspect, the slider member can be formed as a movable member actuable along a mold-facing surface of the first-mold half. In an example, the mold-facing surface of the first mold-half can be the surface facing the direction in which the first mold-half and the second mold-half can be brought together for closing the mold cavity. For example, the slider member can be movable towards and away from a center of the mold cavity. In an example, the direction of the movement of the slider member can be along a direction to modify a draft angle provided in the mold cavity. In addition, the same molding apparatus may be used to mold components having different dimensions.

During operation, in one example, the mold cavity can be closed by assembling the second mold-half with the first mold-half. In another example, an insert can be positioned in the open cavity formed by the slider member and the first mold-half, and the mold cavity can be closed by the second mold-half. In one example, the insert is the component which is to be molded with another material, i.e., the molten material.

According to an aspect of the present subject matter, when the first mold-half is assembled with the second mold-half, the slider member can be actuated towards the mold cavity. As a result, the draft angle is minimized to minimize the tolerances. Further, when molten material is poured into the mold cavity, the lack of gap between the slider member and the insert prevents the overflow of the molten material. Accordingly, a molded component of a high quality can be obtained. In case, the insert is positioned in the mold cavity, the actuation of the slider member brings the slider member in contact with the insert, and any gap between the slider member and the insert is made almost negligible. Accordingly, when the molten material is poured into the mold cavity, such low tolerances allow for the molded component to achieve the relevant dimensions with slight or no variations. As a result, further processing of the molded component to achieve the relevant may consume considerably less time, or may not have to be done.

The above aspects are further described in the figures and in associated description below. It should be noted that the description and figures merely illustrate principles of the present subject matter. Therefore, various arrangements that encompass the principles of the present subject matter, although not explicitly described or shown herein, can be devised from the description and are included within its scope. Additionally, the word “coupled” is used throughout for clarity of the description and can include either a direct connection or an indirect connection.

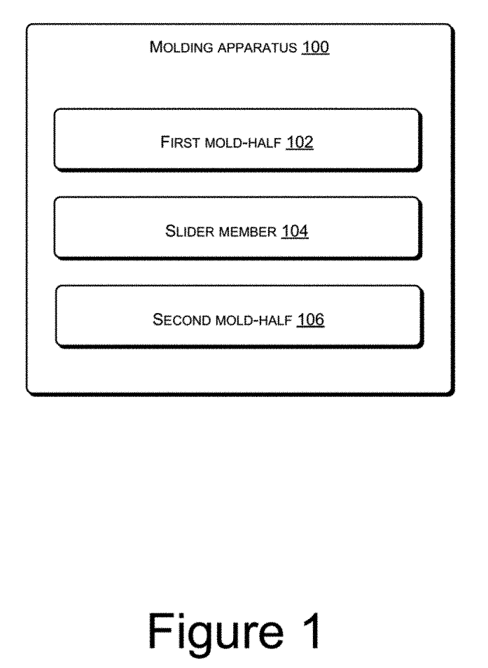

FIG. 1 illustrates a molding apparatus 100, in accordance with an example of the present subject matter. In one case, the molding apparatus 100 may be used to manufacture articles made from a single molding material. In another case, the molding apparatus 100 may be used to manufacture molded insert composites made from an insert and the molding material. In an example, the insert may be a metal part or carbon fiber part or a combination thereof. Further, in an example, the molding material can be a polymer, a ceramic, glass, a carbon fiber, a metal, or a combination thereof. For instance, the molding apparatus 100 may be used for molding a polymer on a metal part.

According to said example, the molding apparatus 100 may include a first mold-half 102, for example, to serve as a base of the molding apparatus 100. Further, the first mold-half 102 may include a mold-facing surface. According to an aspect, the molding apparatus 100 may include a slider member 104 that may be mounted on the mold-facing surface of the first mold-half 102. In an example, the slider member 104 and the first mold-half 102 can together form a mold cavity in which a component can be molded. The mold-facing surface may form a first non-lateral wall of the mold cavity and the slider member 104 may form the lateral walls of the mold cavity.

Further, the molding apparatus 100 may include a second mold-half 106 that may cooperate with the first mold-half 102 and the slider member 104 to complete the mold cavity. In an example, the second mold-half 106 may form another non-lateral wall of the mold cavity along with the first mold-half 102 and the slider member 104. In another example, the second mold-half 106 can partially form the lateral wall and can partially form the non-lateral wall of the mold cavity.

According to an aspect, the slider member 104 may be slideable substantially along the mold-facing surface to vary dimensions of the mold cavity, for instance, based on the size of the molded component to be obtained. In other words, the slider member 104 can modify the draft angle of the mold cavity such that deposition of excessive molding material may be minimized. In addition, the molding apparatus 100 may be used to mold components of various dimensions. In an example, the slider member 104 can be provided as a plurality of slider members 104 slidable over the mold-facing surface to vary the dimensions of the mold cavity. In another example, the slider member 104 can be provided as a single component, and in such a case, the lateral wails can be partly formed by the first mold-half 102 and partly by the slider member 104.

As mentioned previously, the molding apparatus 100, in accordance with the present subject matter, may be employed to mold the molded components made from various types of materials. For example, based on the type of material, the molding apparatus 100 may be employed in various types of systems. In an example, the molding apparatus 100 may be installed in a die-casting machine to mold metallic components. In another example, the molding apparatus 100 may be employed in an injection molding system to mold plastic based molded components.

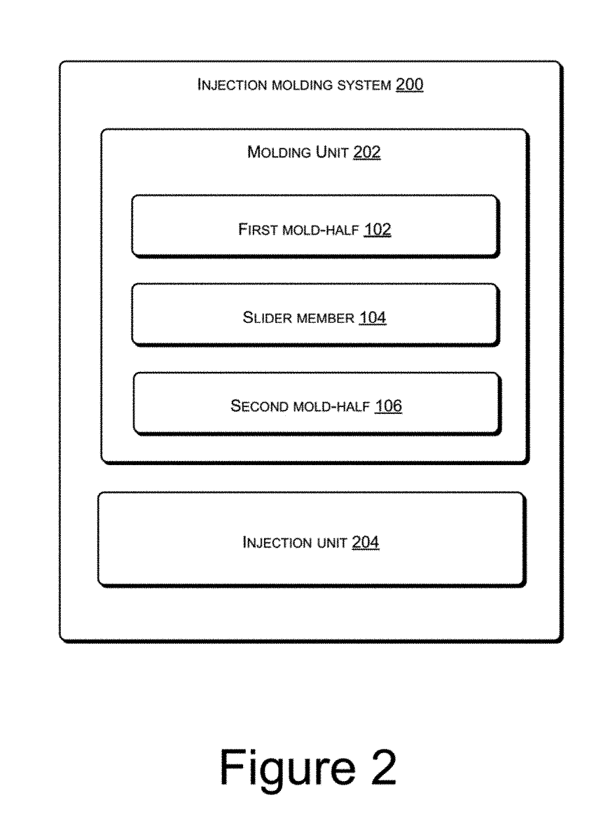

FIG. 2 illustrates an injection molding system 200, in accordance with an example of the present subject matter. The injection molding system 200 can employ the molding apparatus 100, as described with reference to FIG. 1. For example, the molding apparatus 100 can be deployed as a molding unit 202 in the injection molding system 200 and can be used for molding the material to obtain the molded component. For instance, the molding unit 202 may have similar constructional features as the molding apparatus 100 as described with respect to FIG. 1. Accordingly, the molding unit 202 may include the first mold-half 102, the second mold-half 106, and the slider member 104. Further, the first mold-half 102, the second mold-half 104, and the slider member 106 may together form the mold cavity which may be used for molding the material, either as a single material or along with the insert.

According to an example of the present subject matter, the injection molding system 200 may further include an injection unit 204 that may inject the molten molding material in the mold cavity for molding insert with the molding material. In another example, the injection unit 204 may inject the molten molding material in the mold cavity to form the molded component of a single polymer. In one example, the injection unit 204 may include a heater that may melt the molding material, such as polymer granules, to obtain the molten molding material. Further, the injection unit 204 may include one or more injectors that may inject the molten molding material into the mold cavity.

Further, the injection molding system 200 may include an ejection apparatus (not shown) that may be used for removing the molded component from the mold cavity. In one example, the ejection apparatus may be formed as a part of the molding unit 202. In another example, the ejection apparatus may be formed as separate entity. Further, in an instance, the injection molding system 200 may include a controller to regulate the operation of the injection molding system 200. In an example, the controller may include, but not limited to, Programmable logic controller (PLC), microcontroller, microprocessor, or the like.

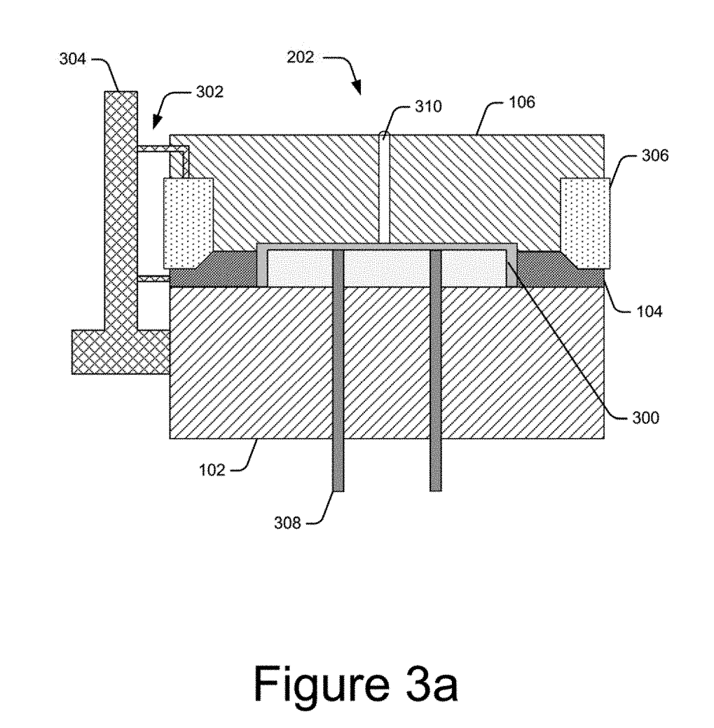

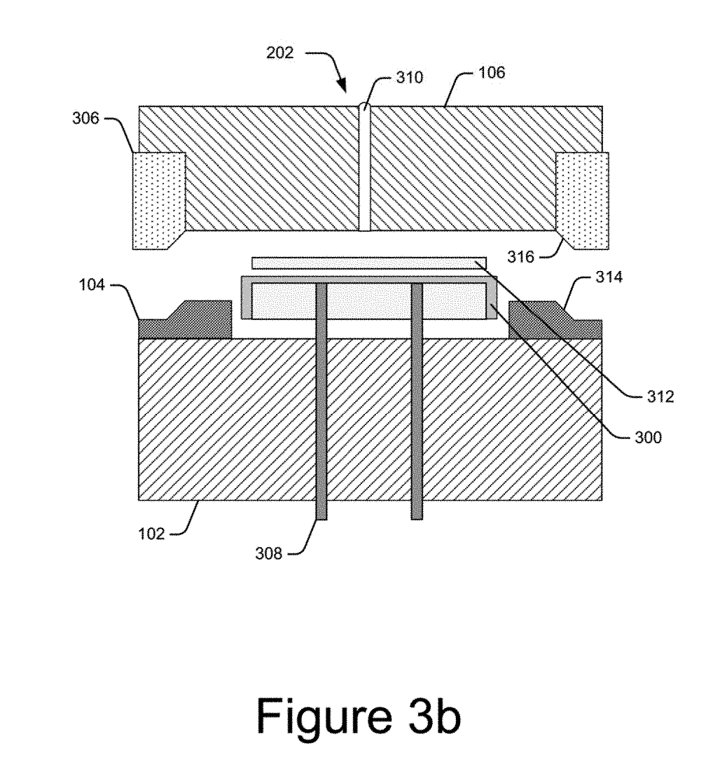

FIG. 3a and FIG. 3b illustrate cross-sectional views of the molding unit 202 of the injection molding system 200, in accordance with one example of the present subject matter. While FIG. 3a illustrates an assembled view of the molding unit 202, FIG. 3b illustrates an exploded view of the molding unit 202. For the sake of brevity and ease of understanding, FIG. 3a and FIG. 3b are explained in conjunction.

As mentioned previously, the molding unit 202 may include the first mold-half 102 having the mold-facing surface. Further, the molding unit 202 may include the slider member 104 mounted on the mold-facing surface in a manner that the slider member 104 may be actuable, for example, slideable, substantially along the mold-facing surface. For instance, the molding unit 202 may include an elastic member (not shown) that may couple the slider member 104 to the mold-facing surface. In an example, the elastic member may be an expansion spring that may be stretched upon actuation of the slider member 104 and may relax to bring the slider member 104 to initial position on the mold-facing surface. Further, in one example, the slider member 104 may be formed of stainless steel. For instance, the slider member 104 can be made of SUS420 grade of stainless steel.

Further, the first mold-half 102 and, the slider member 104 may together form a part of the mold cavity. For example, the mold-facing surface may form a first non-lateral wall of the mold cavity and the slider member 104 may form the lateral wall of the mold cavity. The second mold-half 106 can be installed with the first mold-half 102 or the slider member 104, or both. The second mold-half 106 may be installed on a platform (not shown in) that may be raised or lowered to place and displace the second mold-half 102 from the first mold-half 102.

The second mold-half 106 can foam a second non-lateral wall of the mold cavity and complete the mold cavity, when assembled with the first mold-half 102 and the slider member 104. In other words, the second mold-half 106, the slider member 104, and the first mold-half 102 may together complete the mold cavity in which the first non-lateral wall is formed by the first mold-half 102, the lateral walls may be formed by the slider member 104, and the second non-lateral wall can be formed by the second mold-half 106.

In another example, the second mold-half 106 can be directly assembled with the first mold-half 102 to form the mold cavity. In such an example, the first mold-half 102 can have a hollow region in a body portion to accommodate the slider member 104. For instance, the hollow region can be formed between a mold-facing surface and an interfacing surface of the first mold-half 104, the interfacing surface being the surface which directly cooperates with the second mold-half 106 for assembly.

As explained previously, the injection molding system 200 can be used for molding components made from a single molding material or for molding composites made from an insert 300 and the molding material. In an example, the insert 300 may be a metal part or carbon fiber part or a combination thereof. Further, in an example, the molding material can be a polymer, a ceramic, glass, a carbon fiber, a metal, or a combination thereof. For instance, the injection molding system 200 may be used for molding a polymer on a metal part.

During operation of the injection molding system 200, in one example where the molding unit 202 is used for molding an insert molded component, the insert 300 may be placed in an open mold cavity before the first mold-half 102, the slider member 104, and the second mold-half 106 have been assembled. For example, the insert 300 may be placed such that a center of the insert 300 may get aligned with the center of the mold-facing surface. Further, based on the size of the insert 300, the slider member 104 may be moved such that the walls of the slider member 104, i.e., the walls of the slider member 104 forming the lateral walls of the mold cavity, may abut with the insert 300.

In another example where the molding unit 202 is used for molding a single material, the slider member 104 can be actuated to move towards the mold cavity to modify the draft angle. For example, with such a movement, the draft angle may be minimized to almost negligible. As explained previously, the draft angle can be an outward taper from the non-lateral wall of the first mold-half 102 to an open edge of the slider member 104, provided in the lateral walls of the mold cavity.

In addition, the slider member 104 can be held in such a position and the injection unit 204 may deliver, into the mold cavity, the molding material to be molded, in one case, adjacent to the insert 300. In one example, the injection unit 204 can deliver the molten molding material to the mold cavity adjacent to the insert 300 through a runner 310. For instance, the runner 310 may run through the second mold-half 106 along a thickness of the second mold-half 106. The injection unit 204 can supply the molding material to the mold cavity till the molding material fills the mold cavity and the runner 310 completely. Thereafter, the injection unit 204 can cease the supply of the molding material and the molten molding material can be allowed to cool. In an example, the molten molding material may be deposited on top of the insert 300 in the form of a layer 312. A profile of a surface facing the runner 310 may determine a profile of the layer 312. In another example, the molding material can form the entire molded component on cooling.

With the provision of the movement of the slider member 104 towards the mold cavity or for abutting against the insert 300, as the case may be, can provide for the modification of the draft angle to be made almost negligible. As a result, in one case, such a provision can prevent deposition of excessive molten molding material on the insert 300. In the other case, the substantially negligible draft angle can provide for forming the molded component with considerable accurate dimensions.

According to an aspect, the molding unit 202 may include a pushing assembly 302 that may facilitate the movement of the slider member 104 on the mold-facing surface. In addition, the pushing assembly 302 can ensure that the slider member 104 is held in position, for example, to maintain contact with the insert 300. In one case, the pushing assembly 302 may include an actuator 304 and a block 306 to actuate the slider member 104. In one example, the actuator 304 may be, but is not limited to, hydraulic piston, pneumatic pistons, mechanical actuators, solenoids, or a combination thereof. In one example, the actuators 304 may be directly coupled to the slider member 104 to impart sliding motion to the slider member 104.

In another example, the block 306, in operation, can cooperate with the slider member 104 and the actuator 304 may actuate the block 306 to move the slider member 104. According to said aspect, the slider member 104 may include a wedge-shaped surface 314. In turn, the block 306 may also include a wedge-shaped surface 316 complementary to and to cooperate with the wedge shaped surface 314 of the slider member 104. For instance, the wedge-shaped surfaces 314 and 316 may come in contact with each other. Further, when the block 306 is actuated in a direction substantially perpendicular to the direction that the slider member 104 is capable of moving in, the wedge-shaped surface 314 of the block 306 moves along the wedge-shaped surface of the slider member 104. Accordingly, the wedge-shaped surface 314 of the block 306 applies the force on the movable slider member 104 and actuates the slider member 104 in the direction substantially perpendicular to the direction that the block 306, i.e., towards a center of the mold cavity.

In an example, as shown in FIG. 3a and FIG. 3b, the block 306 can be provided on the second mold-half 106. Accordingly, when the second mold-half 106 is assembled with the first mold-half 102, the block 308 can make contact with the slider member 104. In such a case, the actuator 304 of the pushing assembly 302 may actuate the second mold-half 106 to assemble the second mold-half 106 with the first mold-half 102, and at the same time, to actuate the slider member 104 towards the mold cavity using the block 306 in the manner as described above. In addition, after the molding material in the mold cavity has cooled, the actuator 304 may dissemble the second mold-half 106 from the first-mold half 102 to simultaneously separate the block 306 from the slider member 104. Accordingly, the pressure on the slider member 104 can be released and the elastic member may move the slider member 104 back to its initial position.

Additionally, when the slider member 104 is brought back to the initial position, i.e., away from the mold cavity or the insert 300, the slider member 104 may again form the draft angle. Accordingly, in another example, the slider member 104 can be pivotable about a point on the first mold-surface 102 to allow for such a modification of the draft angle, to abut against the insert 300 and to retract away. The movement of the slider member 104 can still be along the mold-facing surface, since the lateral walls of the slider member 104 are to move substantially in the direction along the mold facing surface to modify the draft angle. Such a provision of modifying the gap between the molded component and the slider member 104 can allow for a convenient withdrawal of the molded component from the mold cavity.

Further, according to an aspect, the molding unit 202 may include an ejection apparatus 308 to facilitate the removal of the molded component from the mold cavity. In one example, the ejection apparatus 308 can be a plurality of rods that may be used to push the molded component out of the mold cavity after the molten molding material has solidified.

Further, as the block 306 slides further downwards, the wedge-shaped surface 314 of the block 306 may push the wedge-shaped surface of the slider member 104. In effect, the wedge-shaped surface of the slider member 104 may slide against the wedge-shaped surface 314 of the block 306 and the slider member 104 may be pushed to the center of the mold-facing surface. The slider member 104 may slide till the sides of the slider member 104 abut with the sides of the insert 300. Further, when the slider member 104 moves, the elastic member coupled to the slider member 104 may also get stretched. During operation, the slider member 104 may remain abut.

After the second mold-half 102 has been raised, the ejection apparatus 308 may push the molded component out of the mold cavity. Thereafter, the molded component may be taken out of the molding unit 202 for post molding operation to obtain a finished molded component.

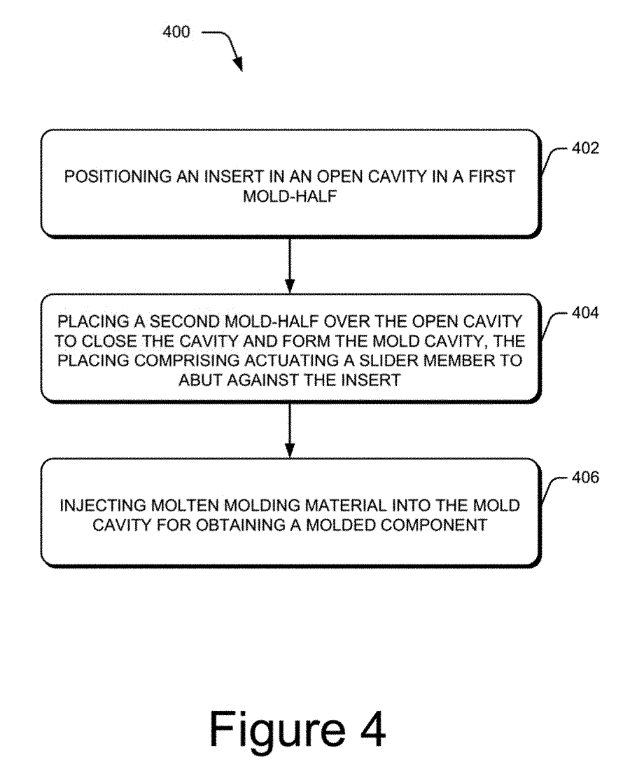

Method 400 described in FIG. 4 illustrates a method for molding a molded component, according to an example of the present subject matter. The order in which the method 400 are described is not intended to be construed as a limitation, and any number of the described method blocks can be combined in any appropriate order to carry out the method 400, or an alternative method. Additionally, individual blocks may be deleted from the method 400 without departing from the spirit and scope of the subject matter described herein. In an example, the method 400 may be performed by the injection molding system 200 deploying the molding apparatus 100 in the form of the molding unit 202.

Referring to FIG. 4, at block 402, the insert 300 may be placed in an open cavity, i.e. the open mold cavity, formed in the first mold-half 102. For example, the insert 300 can be positioned before the first mold-half 102 and the second mold-half 106 have been assembled. For example, the insert 300 may be placed such that a center of the insert 300 may get aligned with the center of the mold-facing surface.

At block 404, the second mold-half 106 can be positioned over the open cavity, to close the cavity to form the mold cavity. In addition, in one example, the slider member 104 may be actuated to move in a direction of the insert 300 to abut against the insert 300. In said example, as explained previously, the second mold-half 106 may be assembled with the first mold-half 102 to actuate, at the same time, the slider member 104, for instance, using the block 306, so that the walls of the slider member 104 forming the lateral walls of the mold cavity, may abut with the insert 300. In another example, the slider member 104 can be actuated independently and after the second mold-half 106 is already assembled with the first mold-half 102.

Further, in case where the material is molded without the insert 300, the slider member 104 can simply be actuated to move towards a center of the mold cavity to modify the draft angle.

At block 406, molten molding material can be injected into the mold cavity for molding the molded component. In an example, the molded component can be the insert 300 molded with the molding material. In another example, the molded component can be entirely made of the molding material without the insert 300.

Although aspects of molding the molded component have been described in language specific to structural features and/or methods, it is to be understood that the appended claims are not limited to the specific features or methods described. Rather, the specific features and methods are disclosed as examples for molding the molded component.

I/Wee claim:

1. A molding apparatus comprising:
a first mold-half comprising a mold-facing surface;
a slider member mounted on the first mold-half and movable along the mold-facing surface of the first mold-half, wherein the first mold-half and the slider member form a part of a mold cavity therebetween; and
a second mold-half to cooperate with the first mold-half to complete the mold cavity with the first mold-half and the slider member, wherein the slider member is to move in to modify a draft angle provided in the mold cavity.

2. The molding apparatus as claimed in claim 1, wherein the second mold-half comprises a pushing assembly to move the slider member, the pushing assembly comprising:
a block to cooperate with the slider member; and
an actuator to actuate the block to move the slider member.

3. The molding apparatus as claimed in claim 2, wherein the slider member comprises a wedge-shaped surface cooperating with the block having a wedge-shaped surface complementary to the wedge shaped surface of the slider member, wherein the block is to apply a force In a direction substantially perpendicular to the direction of movement of the slider member.

4. The molding apparatus as claimed in claim 1, wherein the slider member is made of stainless steel.

5. The molding apparatus as claimed in claim 1, wherein the slider member is mounted on the first mold-part using an elastic member.

6. A method comprising:
positioning an insert in an open cavity in a first mold-half, the open cavity being formed by a mold-facing surface of the mold-half and a slider member movably disposed on the mold facing surface to move substantially along the mold-facing surface;
placing a second mold-half over the open cavity to close the cavity and form the mold cavity, the placing comprising actuating the slider member to abut the slider member against the insert; and
injecting a molding material in molten form into the mold cavity for molding the insert with the molding material to form a molded component.

7. The method as claimed in claim 6, wherein the insert is made of a metal, carbon fiber, or a combination thereof.

8. The method as claimed in claim 6, wherein the molding material is one of a polymer, a ceramic, glass, a carbon fiber, a metal, and a combination thereof.

9. An injection molding system comprising:
a molding unit comprising,
a first mold-half comprising a mold-facing surface to form a first non-lateral wall of a mold cavity;
a slider member mounted on the mold-facing surface, the slider member being movable substantially along the mold-facing surface, wherein the slider member is to form a lateral wall of the mold cavity; and
a second mold-half to form a second non-lateral wall of the mold cavity, wherein the second mold-half is to cooperate with the first mold half and the slider member for forming the mold cavity between the first non-lateral wall, the second non-lateral wall, and the lateral wall, to accommodate an insert, wherein the slider member is to move in a direction of the insert to abut against the insert; and
an injection unit to inject a molding material in molten form into the mold cavity for molding the insert with the molding material to mold a molded component.

10. The injection molding system as claimed in claim 9, wherein the second mold-half comprises a pushing assembly to move the slider member, the pushing assembly comprising:
a block to cooperate with the slider member; and
an actuator to actuate the block to move the slider member.

11. The injection molding system as claimed in claim 10, wherein the slider member comprises a wedge-shaped surface cooperating with the block having a wedge-shaped surface complementary to the wedge shaped surface of the slider member, wherein the block is to apply a force in a direction substantially perpendicular to the direction of movement of the slider member.

12. The injection molding system as claimed in claim 9, wherein the slider member is made of stainless steel.

13. The injection molding system as claimed in claim 9, further comprising an elastic member to couple the slider member to the mold-facing surface of the first mold-part.

14. The injection molding system as claimed in claim 9, further comprising an ejection apparatus for drawing the molded component from the mold cavity.

15. The injection molding system as claimed in claim 9, wherein the insert is made of a metal, carbon fiber, or a combination thereof.
